(19) United States
(12) Patent Application Publication
(10) Pub. No.: US 2011/0169425 A1
(43) Pub. Date: Jul. 14, 2011

(54) SINGLE CHIP BALLAST CONTROLLER FOR STEP-DIMMING OF A FLUORESCENT LAMP

(75) Inventors: Chang-Ling Sha, Hsin-Chu City (TW); Ko-Ming Lin, Hsin-Chu City (TW); Yen-Ping Wang, Hsin-Chu City (TW); Pei-Yuan Chen, Hsin-Chu City (TW); Jian-Shen Li, Hsin-Chu City (TW)

(73) Assignee: GRENERGY OPTO, INC., Hsin-Chu City (TW)

(21) Appl. No.: 12/687,560

(22) Filed: Jan. 14, 2010

(51) Int. Cl. H05B 37/02

(52) U.S. Cl. 315/307

(57) ABSTRACT

The present invention relates a single chip ballast controller for step-dimming of a fluorescent lamp, comprising: a counting circuit, used to generate a switching count by counting the instances where the supply voltage falls below a threshold voltage; a reference voltage generator, used to generate a reference voltage proportional to the switching count; and a gating signal generator, used to generate a high side driving signal and a low side driving signal according to an error voltage between the reference voltage and a current sensing voltage to regulate the current sensing voltage at the reference voltage, wherein the current sensing voltage is proportional to a lamp current flowing through the fluorescent lamp.

### BACKGROUND OF THE INVENTION

1. Field of the Invention

The present invention relates to electronic ballasts for fluorescent lamps, and more particularly to ballast controllers capable of dimming control.

2. Description of the Related Art

In supplying power to light emitting devices such as fluorescent lamps or cold cathode fluorescent lamps or compact fluorescent lamps, electronic ballasts are widely adopted to keep the lamp current stable.

To offer dimming function for electronic ballasts, some prior art ballast controllers have implemented a DIM input pin for receiving a DIM control voltage to provide a dimming control means. The DIM control voltage is generally generated by an additional dial switch (wall dimmer) or a remote control means, and users have to operate the additional dial switch or the remote control means other than an existing lamp rocker switch to trigger the electronic ballast to adjust the luminance of the lamp.

Through the setting of the DIM control voltage, a luminance of the fluorescent lamp corresponding to the setting of the DIM input is generated.

However, since the setting of the DIM control voltage in the prior art has to be done by manipulating an additional dial switch or a remote control means other than an existing lamp switch, users have to pay more cost for the additional dial switch or remote control means. Besides, the additional dial switch may have to be mounted on the wall wherein the wiring between the dial switch and the ballast is bothersome. As to the remote control means, the communication between the transmitter and the receiver needs power, and if the remote control means runs out of battery, then there is no way to dim the lamp unless the battery is replaced.

Therefore, there is a need to provide a solution capable of reducing the cost and eliminating the requirement of an additional dial switch or remote control means in implementing a ballast application with dimming function.

Seeing this bottleneck, the present invention proposes a novel topology of a single chip ballast controller capable of dimming the fluorescent lamp stepwise according to the count of switching of a corresponding lamp switch, without the need of any additional dial switch or remote control means.

### SUMMARY OF THE INVENTION

One objective of the present invention is to provide a ballast controller with step-dimming control from power line sensing which does not require any additional dial switch or remote control means in the luminance adjustment of the lamp.

Another objective of the present invention is to provide a ballast controller with step-dimming function which is triggered according to the count of switching of a corresponding lamp switch.

Still another objective of the present invention is to provide a single chip ballast controller with concise architecture, which can control the luminance of the lamp by regulating the lamp current according to the count of the switching of a corresponding lamp switch.

To achieve the foregoing objectives, the present invention provides a single chip ballast controller for step-dimming of a fluorescent lamp, comprising: a counting circuit, used to generate a switching count by counting the instances where the supply voltage falls below a threshold voltage; a reference voltage generator, used to generate a reference voltage proportional to the switching count; and a gating signal generator, used to generate a high side driving signal and a low side driving signal according to an error voltage between the reference voltage and a current sensing voltage to regulate the current sensing voltage at the reference voltage, wherein the current sensing voltage is proportional to a lamp current flowing through the fluorescent lamp. To make it easier for our examiner to understand the objective of the invention, its structure, innovative features, and performance, we use a preferred embodiment together with the accompanying drawings for the detailed description of the invention.

### BRIEF DESCRIPTION OF THE DRAWINGS

FIG. 1 is a block diagram of a ballast circuit comprising a ballast controller with step-dimming function according to a preferred embodiment of the present invention.

FIG. 2 is a detailed block diagram of a ballast controller with step-dimming function according to a preferred embodiment of the present invention.

FIG. 3 is a detailed block diagram of the gating signal generator in FIG. 2 according to a preferred embodiment of the present invention.

### DETAILED DESCRIPTION OF THE PREFERRED EMBODIMENTS

The present invention will be described in more detail hereinafter with reference to the accompanying drawings that show the preferred embodiment of the invention.

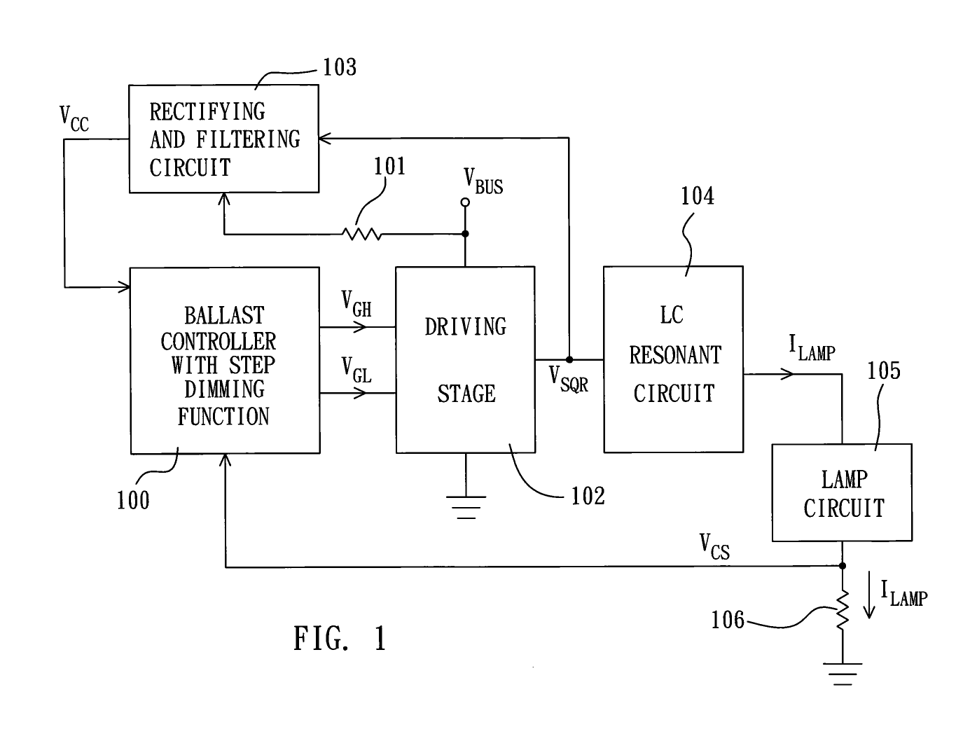

Please refer to FIG. 1, which shows a block diagram of a ballast circuit comprising a ballast controller with step-dimming function according to a preferred embodiment of the present invention. As shown in FIG. 1, the ballast circuit comprises a ballast controller with step-dimming function 100, a start-up resistor 101, a driving stage 102, a rectifying and filtering circuit 103, a LC resonant circuit 104, a lamp circuit 105 and a current sensing resistor 106.

The ballast controller with step-dimming function 100 is used to generate a pair of non-overlapping driving signals composed of a high side driving signal V_{GH} and a low side driving signal V_{GL} according to an error voltage between a reference voltage and a current sensing voltage V_{CS}. The reference voltage is generated according to a count of instances where a supply voltage V_{CC} falls below a threshold voltage due to an existing lamp rocker switch being switched off temporarily, and the current sensing voltage V_{CS} is generated according to a lamp current I_{LAMP}. The high level durations of the high side driving signal V_{GH} and the low side driving signal V_{GL}, non-overlapping with each other, are controlled by the error voltage in a way that the high level durations of the high side driving signal V_{GH} and the low side driving signal V_{GL} vary in the same direction as the error voltage, so when the error voltage increases—it means the lamp current I_{LAMP} is below an expected value—the high level durations of the high side driving signal V_{GH} and the low side driving signal V_{GL} will be prolonged to have more energy delivered to the lamp circuit 105 to increase the lamp current I_{LAMP}. In a finite period, the error voltage will be brought to around zero.

The start-up resistor 101, coupled to the rectifying and filtering circuit 103, is used to provide a start-up current path for building the supply voltage V_{CC} from a main input voltage V_{BUS}.

The driving stage 102, powered by the main input voltage V_{BUS}, is used to generate a square signal V_{SQR} at an output end with a high level and a low level according to the high side driving signal V_{GH} and the low side driving signal V_{GL}. The high level of the square signal V_{SQR} is provided by connecting the output end through a first switch—turned on in the high level duration of the high side driving signal V_{GH}—to the main input voltage V_{BUS}, and the low level of the square signal V_{SQR} is provided by connecting the output end through a second switch—turned on in the high level duration of the low side driving signal V_{GL}—to a reference ground. The first switch preferably comprises a high side NMOS transistor and the second switch preferably comprises a low side NMOS transistor.

The rectifying and filtering circuit 103 is used to provide the supply voltage V_{CC}. In the start-up period, the supply voltage V_{CC} is charged up by the main input voltage V_{BUS} via the start-up resistor 101 to enable the ballast controller with step-dimming function 100 to generate the high side driving signal V_{GH} and the low side driving signal V_{GL}, and thereby the square signal V_{SQR} of the driving stage 102. The rectifying and filtering circuit 103 then rectifies and filters the square signal V_{SQR} to generate the supply voltage V_{CC}.

The LC resonant circuit 104 acts as a band-pass filter to process the square signal V_{SQR} to generate the lamp current I_{LAMP} having a resonant waveform.

The lamp circuit 105 comprises a fluorescent lamp of which the luminance varies in the same direction as the root-mean-squared value of the lamp current I_{LAMP}, and the current sensing resistor 106 is used to carry the lamp current I_{LAMP} to provide the current sensing voltage V_{CS}.

When a user has switched the existing lamp rocker switch on-and-off for a certain times, the ballast controller with step-dimming function 100 will generate a corresponding reference voltage, and the high side driving signal V_{GH} and the low side driving signal V_{GL} will cause the current sensing voltage V_{CS} to approach the corresponding reference voltage, and the step-dimming of the fluorescent lamp is accomplished. Besides, the ballast controller with step-dimming function 100 can be a single chip or it can be integrated with the driving stage 102 into a single chip.

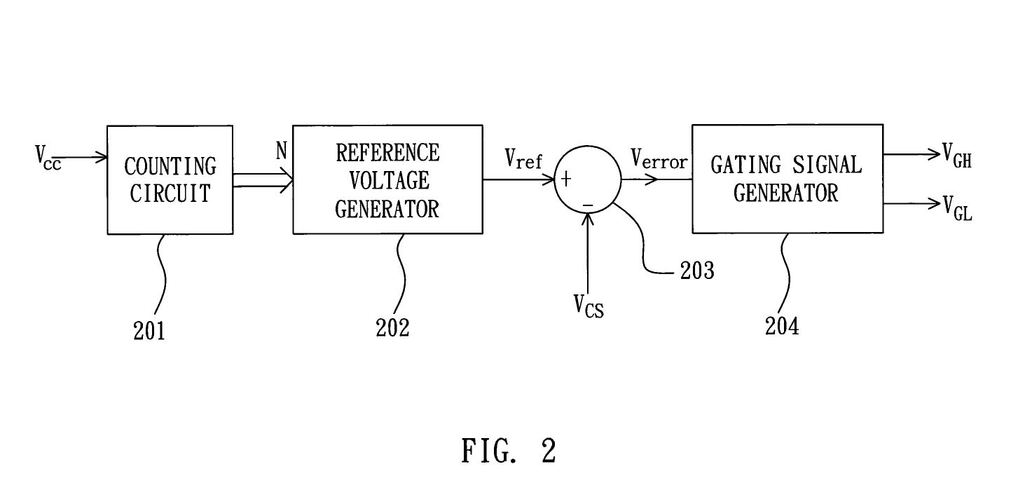

Please refer to FIG. 2, which shows a detailed block diagram of a ballast controller with step-dimming function according to a preferred embodiment of the present invention. As shown in FIG. 2, the ballast controller with step-dimming function comprises a counting circuit 201, a reference voltage generator 202, a combiner 203 and a gating signal generator 204.

The counting circuit 201 preferably comprises: a comparator, used to compare the supply voltage V_{CC} with the threshold voltage to generate a switching sensing pulse signal; and a counter, triggered by the switching sensing pulse signal to generate a switching count N.

The reference voltage generator 202 preferably comprises a Digital-to-Analog converter to generate a reference voltage V_{ref} according to the switching count N.

The combiner 203 is used to subtract the reference voltage V_{ref} with the current sensing voltage V_{CS} to generate an error voltage Vₑᵣᵣₒᵣ.

The gating signal generator 204 is used to generate the high side driving signal V_{GH} and a low side driving signal V_{GL} according to the error voltage Vₑᵣᵣₒᵣ to regulate the current sensing voltage V_{CS} at the reference voltage V_{ref}, wherein the current sensing voltage V_{CS} is proportional to the lamp current I_{LAMP}.

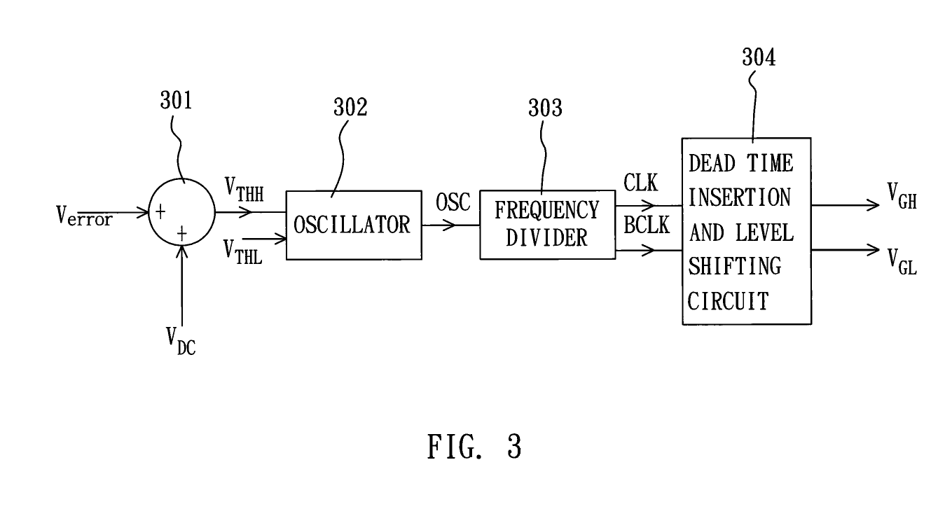

A preferred embodiment of the gating signal generator 204 is disclosed in FIG. 3. Please refer to FIG. 3, which shows a detailed block diagram of the gating signal generator 204 in FIG. 2 according to a preferred embodiment of the present invention. As shown in FIG. 3, the gating signal generator comprises a combiner 301, an oscillator 302, a frequency divider 303 and a dead time insertion and level shifting circuit 304.

The combiner 301 is used to add the error voltage Vₑᵣᵣₒᵣ with a DC voltage V_{DC} to generate a high threshold voltage V_{THH}.

The oscillator 302, preferably but not limited to an astable type, is used to generate an oscillating signal OSC according to the high threshold voltage V_{THH} and a low threshold voltage V_{THH}. The frequency of the oscillating signal OSC varies in the opposite direction as the high threshold voltage V_{THH}, i.e., as the level of the high threshold voltage V_{THH} goes up/down, the frequency of the oscillating signal OSC will become lower/higher.

The frequency divider 303 is used to divide the frequency of the oscillating signal OSC to generate a pair of complementary clock signals CLK and CLKB.

The dead time insertion and level shifting circuit 304 is used to insert a dead time between the pair of complementary clock signals CLK and CLKB and up shift the pair of complementary clock signals CLK and CLKB to generate the high side driving signal V_{GH} and the low side driving signal V_{GL}.

Through the implementation of the present invention, a single-chip ballast controller for step-dimming of a fluorescent lamp by sensing the switching count of a lamp switch and sensing the lamp current is presented. The topology of the present invention is much more concise than prior art circuits, so the present invention does conquer the disadvantages of prior art circuits.

While the invention has been described by way of examples and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance than the conventional structure and further complies with the patent application requirements and is submitted to the Patent and Trademark Office for review and granting of the commensurate patent rights.

What is claimed is:

1. A single chip ballast controller for step-dimming of a fluorescent lamp, comprising:
a counting circuit, used to generate a switching count by counting the instances where said supply voltage falls below a threshold voltage;
a reference voltage generator, used to generate a reference voltage proportional to said switching count; and
a gating signal generator, used to generate a high side driving signal and a low side driving signal according to an error voltage between said reference voltage and a current sensing voltage to regulate said current sensing voltage at said reference voltage, wherein said current sensing voltage is proportional to a lamp current flowing through said fluorescent lamp.

2. The single chip ballast controller for step-dimming of a fluorescent lamp as claim 1, wherein said gating signal generator comprises:
a combiner, used to generate a high threshold voltage according to the sum of said error voltage and a DC voltage;
an oscillator, used to generate an oscillating signal according to said high threshold voltage and a low threshold voltage, wherein the frequency of said oscillating signal is inversely controlled by the level of said high threshold voltage;
a frequency divider, used to divide the frequency of said oscillating signal with a number to generate a pair of complementary clock signals; and
a dead time insertion and level shifting circuit, used to insert a dead time between said pair of complementary clock signals and up shift said pair of complementary clock signals to generate said high side driving signal and said low side driving signal.

3. The single chip ballast controller for step-dimming of a fluorescent lamp as claim 1, further comprising a driving stage with an output end for generating a square signal with a high level and a low level according to said high side driving signal and said low side driving signal, wherein said high level is provided by connecting said output end through a first switch to a main input voltage and said low level is provided by connecting said output end through a second switch to a reference ground.

4. The single chip ballast controller for step-dimming of a fluorescent lamp as claim 3, wherein said first switch comprises a high side NMOS transistor, and said second switch comprises a low side NMOS transistor.

5. The single chip ballast controller for step-dimming of a fluorescent lamp as claim 1, wherein said counting circuit comprises:
a comparator, used to compare said supply voltage with said threshold voltage to generate a switching sensing pulse signal; and
a counter, triggered by said switching sensing pulse signal to generate said switching count.

6. The single chip ballast controller for step-dimming of a fluorescent lamp as claim 1, wherein said reference voltage generator comprises a Digital-to-Analog converter.

7. A single chip ballast controller for step-dimming of a fluorescent lamp, comprising:
a counting circuit, used to generate a switching count by counting the instances where said supply voltage falls below a threshold voltage;
a reference voltage generator, used to generate a reference voltage proportional to said switching count;
a gating signal generator, used to generate a high side driving signal and a low side driving signal according to an error voltage between said reference voltage and a current sensing voltage to regulate said current sensing voltage at said reference voltage, wherein said current sensing voltage is proportional to a lamp current flowing through said fluorescent lamp; and
a driving stage, having an output end for generating a square signal with a high level and a low level according to said high side driving signal and said low side driving signal, wherein said high level is provided by connecting said output end through a first switch to a main input voltage and said low level is provided by connecting said output end through a second switch to a reference ground.
